(19) United States
(12) Patent Application Publication
(10) Pub. No.: US 2008/0072950 A1
(43) Pub. Date: Mar. 27, 2008

(54) Communication Apparatus With Solar Cell Charging Capability

(76) Inventors: Kuo-Len Lin, Wugu Township (TW); Tien-Chih Tseng, Wugu Township (TW); Wen-Jung Liu, Wugu Township (TW); Hai-Rui Ye, Wugu Township (TW)

Correspondence Address: HDSL, 4331 STEVENS BATTLE LANE, FAIRFAX, VA, 22033, US

(21) Appl. No.: 11/530,125

(22) Filed: Sep. 8, 2006

(51) Int. Cl. H02N 6/00

(52) U.S. Cl. 136/244; 136/291

(57) ABSTRACT

A communication apparatus with solar cell charging capability includes a hand-held communication device and a solar cell plate movably received in the hand-held communication device. The hand-held communication device includes an accommodation groove defined on one side of the hand-held communication device and the solar cell plate movably is movably received in the accommodation groove. The solar cell plate can be pulled out from the accommodation groove when the battery of the hand-held communication device is insufficient. Therefore, the solar cell plate can charge the battery of the hand-held communication device.

### BACKGROUND OF THE INVENTION

1. Field of the Invention

The present invention relates to a communication apparatus with solar cell charging capability, especially to a communication apparatus with movable solar cell plate to charge at least one battery of the communication apparatus at user's disposal.

2. Description of Prior Art

The current mobile electronic devices such as Personal Digital Assistance (PDA) or mobile phone are generally powered by battery. The battery has limited power capacity and the operation time thereof is limited. The charger and power code are inconvenient for user to carry, and the mobile electronic devices are difficult to get power from wall socket, car cigar-lighter or USB port. Therefore, user needs to carry extra battery for back-up power. However, carrying extra batter is also cumbersome to user.

Taiwan patent gazette No. M285126 disclose a solar cell charging device for mobile phone. A solar cell plate is provided to convert solar energy into electrical energy for the power of electric torch, mobile phone charger, mosquito expeller, warning lights, and camping lights.

Moreover, Taiwan patent gazette No. 448600 discloses a solar cell charging device for the batter of mobile phone and method for the same. A solar cell charging device is provided to power the mobile phone, and the excessive electrical power of the solar cell charging device is supplied to the rechargeable battery of the mobile to charge the rechargeable battery.

The above-mentioned prior art solar cell charging devices convert solar energy to electrical energy for supplying the electrical energy to a portable electronic device. However, the solar cell is integrated to a charger separated with the communication device. User needs to carry charger with solar cell and power transmission line, which is also troublesome.

### SUMMARY OF THE INVENTION

The present invention is to provide a communication apparatus with solar cell charging capability, wherein a solar cell plate is movably received in a space of the communication apparatus. The solar cell plate can be pulled out to charge at least one battery in the communication apparatus.

Accordingly, the present invention provides a communication apparatus with solar cell charging capability, comprising:

a hand-held communication device comprising an accommodation groove defined on one side of the hand-held communication device, an opening defined on one end of the accommodation groove; and

a solar cell plate movably received in the accommodation groove, which can be pulled out from the accommodation groove and charge at least one battery in the hand-held communication device.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a perspective view of the present invention, where the communication apparatus is folded.

FIG. 2 shows a sectional view of the present invention, where the communication apparatus is unfolded.

FIG. 3 shows a perspective view of the present invention, where the communication apparatus is unfolded.

FIG. 4 shows a sectional view of the present invention, where the solar cell plate is received.

FIG. 5 shows a sectional view of the present invention, where the solar cell plate is pulled out.

FIG. 6 shows a schematic view of the present invention, where the solar cell plate is pulled out.

FIG. 7 shows a perspective view of the present invention, where the solar cell plate is pulled out.

### DETAILED DESCRIPTION OF THE INVENTION

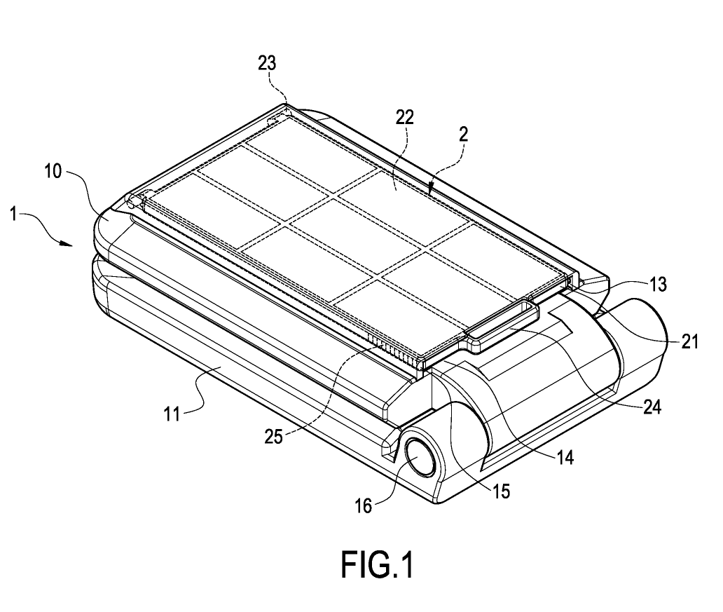

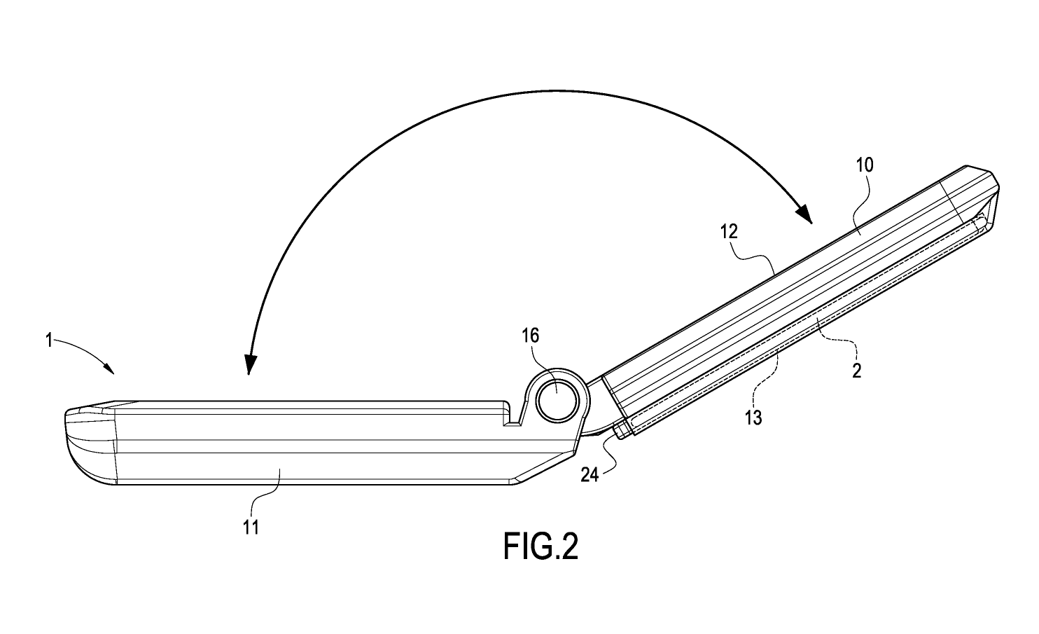

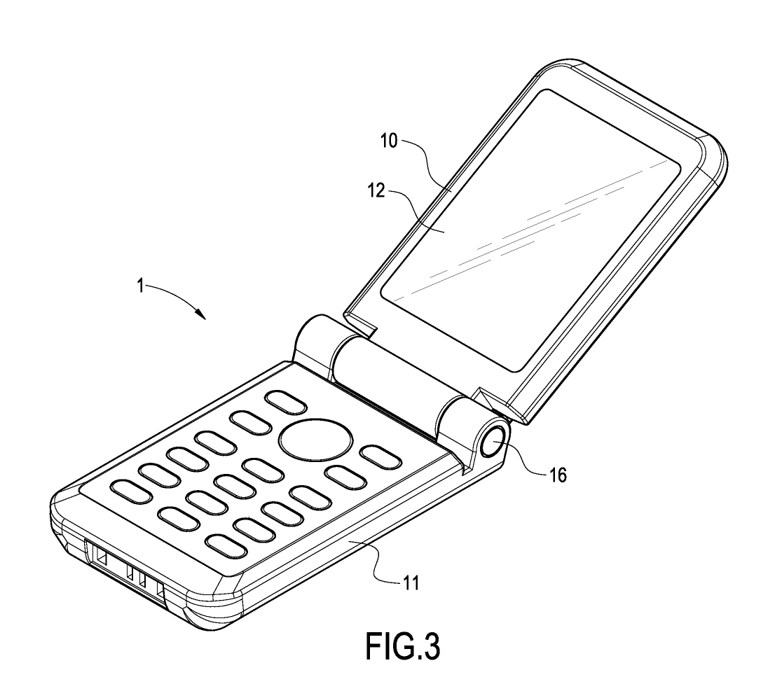

With reference to FIGS. 1 to 3, the communication apparatus with solar cell charging unit mainly includes a hand-held communication device 1 and a solar cell plate 2 received in the hand-held communication device 1. The hand-held communication device 1 includes a main unit 11 and a display 12 connected to the main unit 1 through a rotational shaft 16 to form a foldable mobile phone. The main unit 11 includes a control circuit electrically connected to a battery set (not shown). The display 12 is preferably arranged on a shell 10. An accommodation groove 13 is defined on the shell 10 and on the same side of the display 12. An opening 14 is defined on the accommodation groove 13 and the width of the opening 14 is preferably smaller than that of the accommodation groove 13. A shoulder 15 is formed on inner side of each opening 14. The solar cell plate 2 can be movably arranged in the groove 13 and electrically connected to the control circuit and battery. The solar cell plate 2 can be simultaneously opened with the display 12 and the shell 10 for user.

The hand-held communication device 1 can be non-foldable one. In other word, the groove 13 can be defined on backside of any non-foldable hand-held communication device, or the mounting side for battery.

The solar cell plate 2 includes a base 21 and a plurality of solar cell chips 22 on one side of the base 21. The base 21 includes two clamping sections 23 corresponding to the groove 13 to prevent complete pulling out the solar cell plate 2. A handgrip 24 is arranged on the base 21 and opposite to the clamping sections 23 to facilitate the pulling operation of the solar cell plate 2. Damascenes 25 are formed on two sidewalls of the solar cell plate 2 and corresponding to the groove 13 to provide friction force to the groove 13.

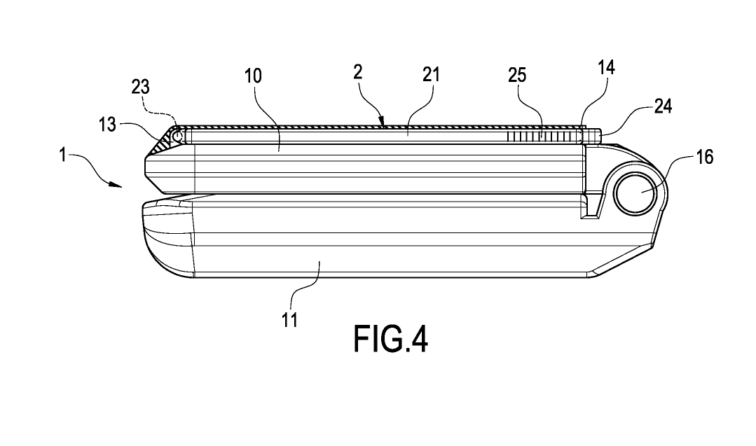

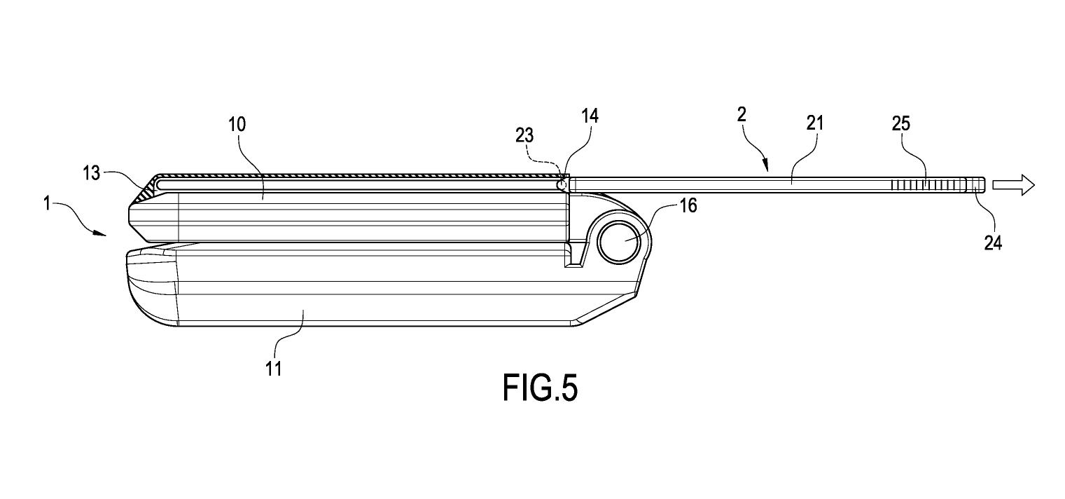

With reference to FIGS. 4 and 5, after the hand-held communication device 1 is assembled, the solar cell plate 2 is arranged in the groove 13. When the battery power of the hand-held communication device 1 is insufficient, user can pull the solar cell plate 2 out of the groove 13 by operating the handgrip 24 through the opening 14. The solar cell chips 22 are arranged on the solar cell plate 2 and convert solar energy into electrical energy to charge the battery in the hand-held communication device 1. After charge is finished, the solar cell plate 2 can be pushed into the groove 13 to end the energy conversion process.

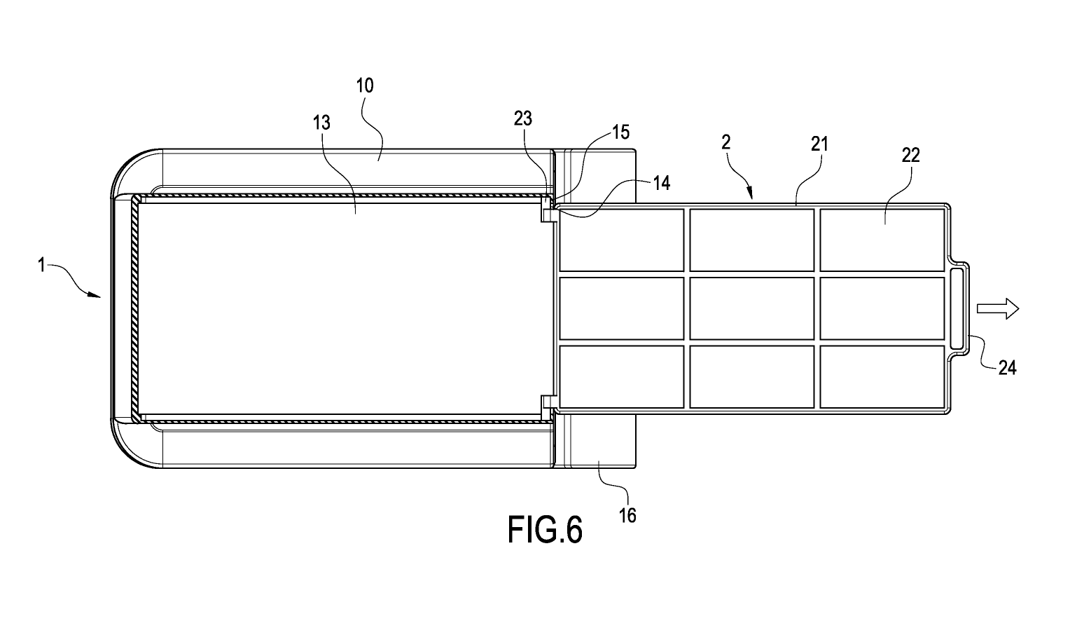

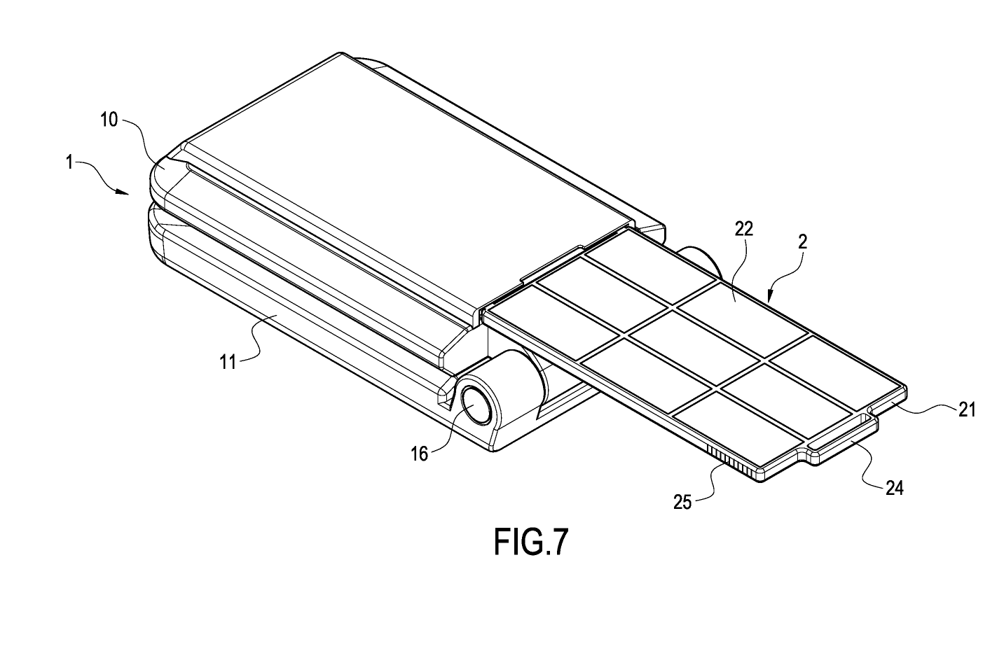

FIGS. 6 and 7 show that the solar cell plate 2 is pulled out and clamped. When the solar cell plate 2 is pulled out from the opening 14 of the groove 13, the solar cell plate 2 is retained by the clamping unit 23, which is abutted against the shoulder 15 of the groove 13.

The hand-held communication device of the present invention includes an accommodation groove to receive the solar cell plate. The solar cell plate is pulled out to charge the battery of the hand-held communication device when the battery power of the hand-held communication device is not sufficient.

The hand-held communication device 1 of the present invention includes an accommodation groove 13, whereby the solar cell plate 2 is movably received in the hand-held communication device 1. The solar cell plate 2 can be pulled out to perform energy conversion and to charge the battery. Therefore, the operation time of the hand-held communication device 1 can be prolonged without needing to carry additional battery.

The solar cell plate 2 and the base 21 thereof is of compact plate shape and can be movably received in the display. Therefore the hand-held communication device 1 of the present invention still can maintain compact size and thin shape.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A communication apparatus with solar cell charging capability, comprising:
a hand-held communication device comprising an accommodation groove defined on one side of the hand-held communication device, an opening defined on one end of the accommodation groove; and
a solar cell plate movably received in the accommodation groove, which can be pulled out from the accommodation groove and charge at least one battery in the hand-held communication device,
wherein the solar cell plate comprises a base, a plurality of solar cell chips on one face of the base, at least one projecting clamping section to arranged on end of the accommodation groove and adapted to prevent complete detachment of the solar cell plate.

2. The communication apparatus in claim 1, wherein the hand-held communication device is a foldable phone comprising a main unit and a display pivotally connected with the main unit.

3. The communication apparatus in claim 2, wherein the display is arranged on one side of a shell and the accommodation groove is defined on another side opposite to the display.

4. The communication apparatus in claim 1, wherein the width of the opening is smaller than the width of the accommodation groove, a shoulder formed on each of two inner sides of the opening.

5. The communication apparatus in claim 1, wherein the base further comprises a handgrip and projected out of the opening.

6. The communication apparatus in claim 5, wherein damascenes are formed on two sidewalls of the solar cell plate and corresponding to the groove to provide friction force to the groove.
